(19) United States
(12) Patent Application Publication
(10) Pub. No.: US 2015/0172816 A1
(43) Pub. Date: Jun. 18, 2015

(54) MICROPHONE INTERFERENCE DETECTION METHOD AND APPARATUS

(71) Applicant: Google Technology Holdings LLC, Mountain View, CA (US)

(72) Inventors: Plamen A. Ivanov, Schaumburg, IL (US); Scott A. Mehrens, Shoreline, WA (US); Kevin J. Bastyr, St. Francis, WI (US); Joel Anthony Clark, Woodridge, IL (US)

(21) Appl. No.: 14/566,281

(22) Filed: Dec. 10, 2014

Related U.S. Application Data
(63) Continuation of application No. 12/822,176, filed on Jun. 23, 2010, now abandoned.

(51) Int. Cl. H04R 3/04; H04R 1/08

(52) U.S. Cl. CPC H04R 3/04; H04R 1/08

(57) ABSTRACT

A method and apparatus for detecting microphone interference includes first and second built-in microphones producing first and second microphone signals. A first filter bank creates first high-frequency-band and first low frequency-band signals from the first microphone signal. A second filter bank creates second high-frequency-band and second low-frequency-hand signals from the second microphone signal. A first measurement calculator determines a high-frequency-band energy value from the first high-frequency-band signal and the second high-frequency-hand signal when the first and second high-frequency-band signals' magnitudes exceeds predetermined thresholds. A second measurement calculator calculates a low-frequency-band energy value from the first low-frequency-band signal and the second low-frequency-band signal when the first and second low-frequency-band signals' magnitudes exceed predetermined thresholds. A logic control block, coupled to the first measurement calculator and the second measurement calculator, detects microphone interference and produces an output signal indicating microphone occlusion or wind noise.

### FIELD OF THE DISCLOSURE

This disclosure relates generally to audio recording by portable electronic devices with built-in microphones.

### BACKGROUND OF THE DISCLOSURE

A port of a built-in microphone of a portable electronic device has a fixed location on the device housing. Generally, the built-in microphone port is visually unobtrusive and a user may inadvertently interfere with an audio recording by placing a hand or finger over the microphone port, rubbing or tapping on the microphone port, subjecting the microphone to unintended wind noise, or subjecting the microphone to too much background noise. More than one microphone port on the device housing increases the chances of a user unintentionally creating microphone interference.

Sometimes these types of microphone interference might be remedied easily by the user. Unfortunately, the user may be unaware of the interference until the user plays back the recorded audio. At playback time, however, it is too late to remedy the microphone interference.

Thus, there is an opportunity to reduce unintentionally-created microphone interference during audio recording. The various aspects, features and advantages of the disclosure will become more fully apparent to those having ordinary skill in the art upon careful consideration of the following Drawings and accompanying Detailed Description.

### BRIEF DESCRIPTION OF THE DRAWINGS

FIGS. 1A and 1B show an example electronic device with two built-in microphones and displaying a notice regarding possible microphone interference.

FIG. 2 shows an example microphone interference detection apparatus.

FIGS. 3A and 3B show an example microphone interference detection method.

FIG. 4 shows the example electronic device of FIG. 1 displaying a second notice regarding possible microphone interference.

FIG. 5 shows the example electronic device of FIG. 1 displaying a third notice regarding possible microphone interference.

FIG. 6 shows the example electronic device of FIG. 1 displaying a fourth notice regarding possible microphone interference.

### DETAILED DESCRIPTION

A method and apparatus for detecting microphone interference includes a first built-in microphone producing a first microphone signal and a second built-in microphone producing a second microphone signal. A first filter bank creates a first high-frequency-band signal and a first low-frequency-band signal from the first microphone signal. A second filter bank creates a second high-frequency-band signal and second low-frequency-band signal from the second microphone signal. A first measurement calculator determines a high-frequency-band energy value from the first high-frequency-band signal and the second high-frequency-band signal when the first high-frequency-band signal's magnitude exceeds a predetermined first threshold and the second high-frequency-band signal's magnitude exceeds a predetermined second threshold. A second measurement calculator calculates a low-frequency-band energy value from the first low-frequency-band signal and the second low-frequency-band signal when the first low-frequency-band signal's magnitude exceeds a predetermined third threshold and the second low-frequency-band signal's magnitude exceeds a predetermined fourth threshold. A logic control block, coupled to the first measurement calculator and the second measurement calculator, detects microphone interference and produces an output signal indicating microphone occlusion or wind noise.

Optionally, a first saturation counter can determine a first saturation count signal from the first microphone signal and a second saturation counter can determine a second saturation count signal from the second microphone signal. The logic control block, when coupled to the first saturation counter and the second saturation counter, can also detect microphone interference in the form of mechanical microphone interference or microphone overload.

The output of the logic control block can be used to try to mitigate the microphone interference. In the examples described below, the output of the logic control block is coupled to a user interface to suggest, to the user of the apparatus, ways to mitigate the interference. In other embodiments, the output of the logic control block could be sent to one or more signal processors to try to mitigate the interference without the user being aware of the interference.

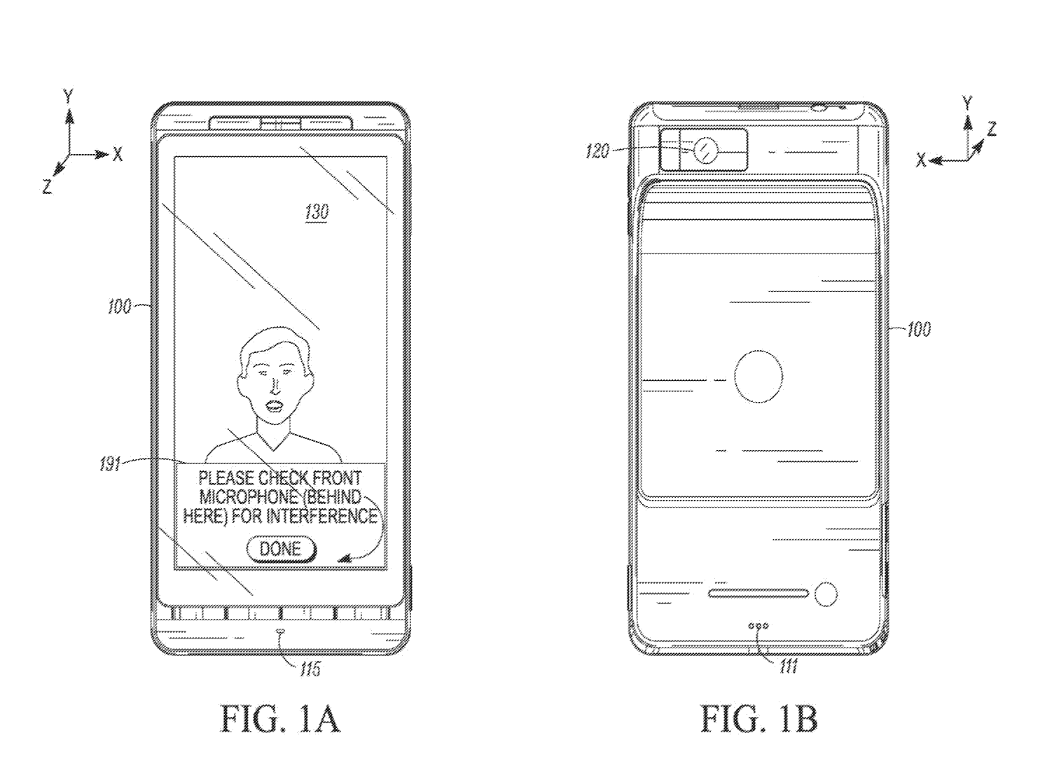

FIGS. 1A and 1B show an example electronic device 100 with two built-in

microphones 111, 115 and displaying a notice 191 regarding possible microphone interference. FIG. 1A shows a rear view of the electronic device 100 while FIG. 1B shows a front view of the electronic device 100. The electronic device 100 shown is a mobile station (sometimes called a mobile phone, user equipment, or cellular telephone) with video recording and playback capabilities as well as wireless communication capabilities. Alternate embodiments of the electronic device could be a dedicated video camera, a dedicated audio recorder, or another type of device incorporating a video camera or audio recorder. For the sake of simplicity, many of the components of the electronic device will not be described in detail. These components include a power supply (e.g., battery or power cord), one or more transceivers (e.g., wired or wireless; wide area network, local area network, and/or personal area network modems), one or more ports, built-in memory, optional removable memory, and various analog and digital controllers.

In this example, the “front” side is determined by a camera 120. Thus, a “front” microphone 111 faces the same direction as the camera 120. This particular designation for “front” is merely a matter of expedience to enable a user to quickly distinguish between the two built-in microphones in this particular example. As a matter of nomenclature, though, either microphone could be considered a “first” microphone with the other microphone being designated a “second” microphone. As shown here, an electronic display 130 is positioned on the electronic device 100 opposite the camera 120. Note, however, that this is merely a matter of configuration and that the electronic display 130 could be been positioned facing the same direction as the camera 120 (e.g., in a web-cam configuration).

In this example, the two built-in microphones 111,115 are closely-spaced and matched. For example, both microphones 111,115 are omnidirectional condenser microphones having matched frequency responses and facing opposite directions. Note that both microphones could alternately be directional capacitive microphones or other types of microphones. Also, the frequency responses could be electronically corrected to match.

When the microphone interference detection apparatus and method detects potential microphone interference, the electronic device 100 provides an annunciation intended to guide the user to mitigate the detected microphone interference. As shown in FIG. 1A, the microphone interference detection apparatus and method has detected some type of interference with the front microphone 111, and the electronic device 100 has provided a visual notice 191 on the display 130 asking the user to check the front microphone 111 for interference. Several types of microphone interference could have triggered the notice 191. One type of interference is mechanical interference caused by an object rubbing or tapping against the front microphone port. Another type of microphone interference is microphone occlusion caused by an object blocking a particular microphone's port. Thus, if the microphone interference and detection apparatus and method detected possible mechanical interference or microphone occlusion of the front microphone 111 or the rear microphone 115, the notification would direct the user to check the appropriate microphone and hopefully influence the user to remove the cause of the interference.

Other types of interference can also be detected. Examples include microphone overload caused by background noise that is too loud for the microphones 111, 115 to handle, and wind noise caused by air pressure and velocity fluctuations near the microphones 111, 115.

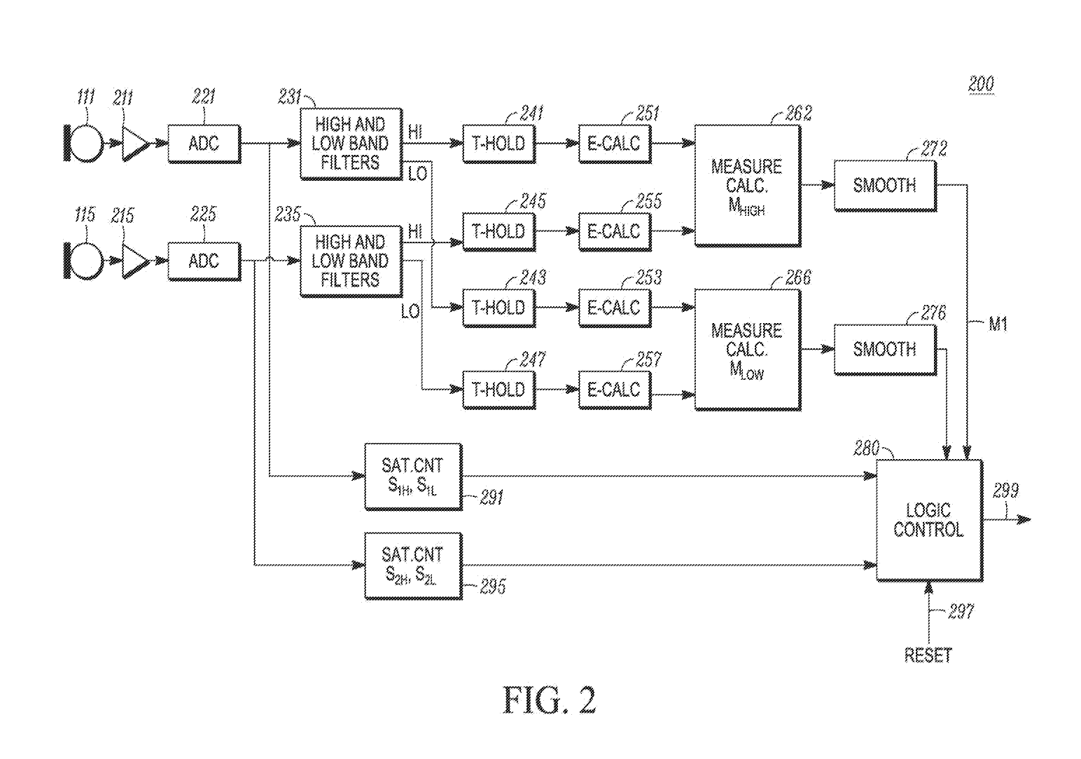

FIG. 2 shows an example microphone interference detection apparatus 200. This apparatus 200 can be implemented in the electronic device 100 shown in FIG. 1. The two microphones 111, 115 each have a corresponding amplifier 211,215 and analog-to-digital converter (ADC) 221, 225. Thus, in this example, the signal from the front microphone 111, amplified by the first amplifier 211, digitized by the first ADC 221, and entering the first filter bank 231 is a pulse-code modulated signal. Similarly, the signal from the rear microphone 115, amplified by the second amplifier 215, digitized by the second ADC 225, and entering the second filter bank 235 is also a pulse-code modulated signal. The PCM signal is implementation-specific and the microphone interference detection apparatus can alternately be implemented in the analog domain or a different digital domain. In this example, the filter banks 231, 235 each include a high-pass filter and a low-pass filter and can be implemented using an audio crossover.

Audio signal components from the front microphone that are above the cutoff frequency for the first high-pass filter are provided to a first threshold block 241, audio signal components from the rear microphone that are above the cutoff frequency for the second high-pass filter are provided to a second threshold block 245, audio signal components from the front microphone that are below the cutoff frequency for the first low-pass filter are provided to a third threshold block 243, and audio signal components from the rear microphone that are below the cutoff frequency for the second low-pass filter are provided to a fourth threshold block 247. In this example, the cutoff frequency for both the first and second high-pass filters is about 400 Hz and the cutoff frequency for both the first and second low-pass filters is about 300 Hz. If the high and low band filters 231, 235 were replaced with audio crossovers, the crossover frequency could be between 300-400 Hz.

For each sampling time period, if the signal magnitude for each signal to each threshold block 241, 243, 245, 247 is below a predetermined threshold, then the signal is not passed to the next stage of the microphone interference detection apparatus. By avoiding the further calculations, the apparatus can save signal processing power when the probability of microphone interference is low (and/or the probability of accurate microphone interference detection is low). In this embodiment, the first and second threshold blocks 241, 243 both use equivalent threshold values, and the third and fourth threshold blocks 243, 247 both use equivalent threshold values. Of course, other embodiments may use different threshold values for each threshold block, the same threshold value for all of the threshold blocks, dynamically varying threshold values, and other variants.

For each of the four signals, if the signal amplitude passes the corresponding threshold, the signal energy during a particularlar sampling time period is calculated as: E=Σᵢ₌₁^{N}xᵢ² Thus, the first energy calculator 251 calculates the energy of the upper-frequency-band signal from the front microphone 111 as E_{1HIGH}, the second energy calculator 255 calculates the energy of the upper-frequency-band signal from the rear microphone 115 as E_{2HIGH}, the third energy calculator 253 calculates the energy of the lower-frequency-band signal from the front microphone 111 as E_{1LOW}, and the fourth energy calculator 257 calculates the energy of the lower-frequency-band signal from the rear microphone 115 as E_{2LOW}.

A first measurement calculator 262 calculates the difference of the high-band energies and normalizes the results to a high-frequency-band energy value as follows:

M_{HIGH}=|(E_{1HIGH}−E_{2HIGH})/(E_{1HIGH}+E_{2HIGH})|

A second measurement calculator 266 calculates the difference of the low-band energies and normalizes the results to a low-frequency-band energy value as follows:

M_{LOW}=|(E_{1LOW}−E_{2LOW})/(E_{1LOW}+E_{2LOW})|.

The high and low frequency band energy values can be calculated using alternate methodologies, such as the energy of the difference between the signals (rather than the difference of the energies of the signals). Also, it is not necessary to normalize the high and low frequency band energy values by (E_{1HIGH}+E_{2HIGH}) and (E_{1LOW}+E_{2LOW}), respectively.

After that, a first smoothing block 272 smoothes out the resulting M₁ signal using a simple smoothing function: M_{HIGH}(n)=αM_{HIGH}(n)+(1−α)M_{HIGH}(n−1). A second smoothing block 276 does the same thing with the M_{LOW} signal from the second measurement calculator 266. Thus, M_{LOW}(n)=αM_{LOW}(n)30 (1−α)M_{LOW}(n−1). Although the value for α is shown as the same for both smoothing blocks 272, 276, the values for α could be different for M_{HIGH} and M_{LOW}.

The two smoothed signals M_{HIGH}(n) and M_{LOW}(n) are provided to a logic control block 280. Although the generation of the smoothed signals M_{HIGH}(n) and M_{LOW}(n) are shown as occurring outside of the logic control block 280, an alternate implementation could place one or more threshold blocks, energy calculators, measurement calculators, or smoothing blocks within the logic control block.

A first saturation count block 291 from the front microphone's ADC 221 provides two saturation counts S_{1H}, S_{1L}, and a second saturation count block 295 from the rear microphone's ADC 225 provides two more saturation counts S_{2H}, S_{2L} the logic control block 280. Each saturation count signal reflects the number of times that an incoming digital signal crosses a predetermined threshold in a given time period. The S_{1H} and S_{2H} saturation counts reflect the number of times that the incoming first and second microphone signals cross a “high” conversion threshold in a given time period. For example, if the ADC maximum positive output is 1 and maximum negative output is −1, then the S_{1H} and S_{2H} saturation counts reflect the number of times, in a given time period, that the saturation count blocks 291, 295 detect the incoming digital signal equaling (or almost equaling) a 1 or −1. Of course, different threshold values (including variable threshold values) can be used instead of the examples given. The S_{1L} and S_{2L} saturation counts reflect the number of times that the incoming first and second microphone signals cross a “low” conversion threshold (“low” simply being lower than the “high” conversion threshold) in the given time period.

A fifth input 297 to the logic control block 280 is a reset signal. This reset signal triggers a reset of the logic control block 280 and can reflect when the electronic device 100 is audibly alerting the user (e.g., incoming phone call ring tone, various beeps for audible feedback to user interactions, or when the electronic device is providing speech instructions to the user) such that these known audible alerts are ignored.

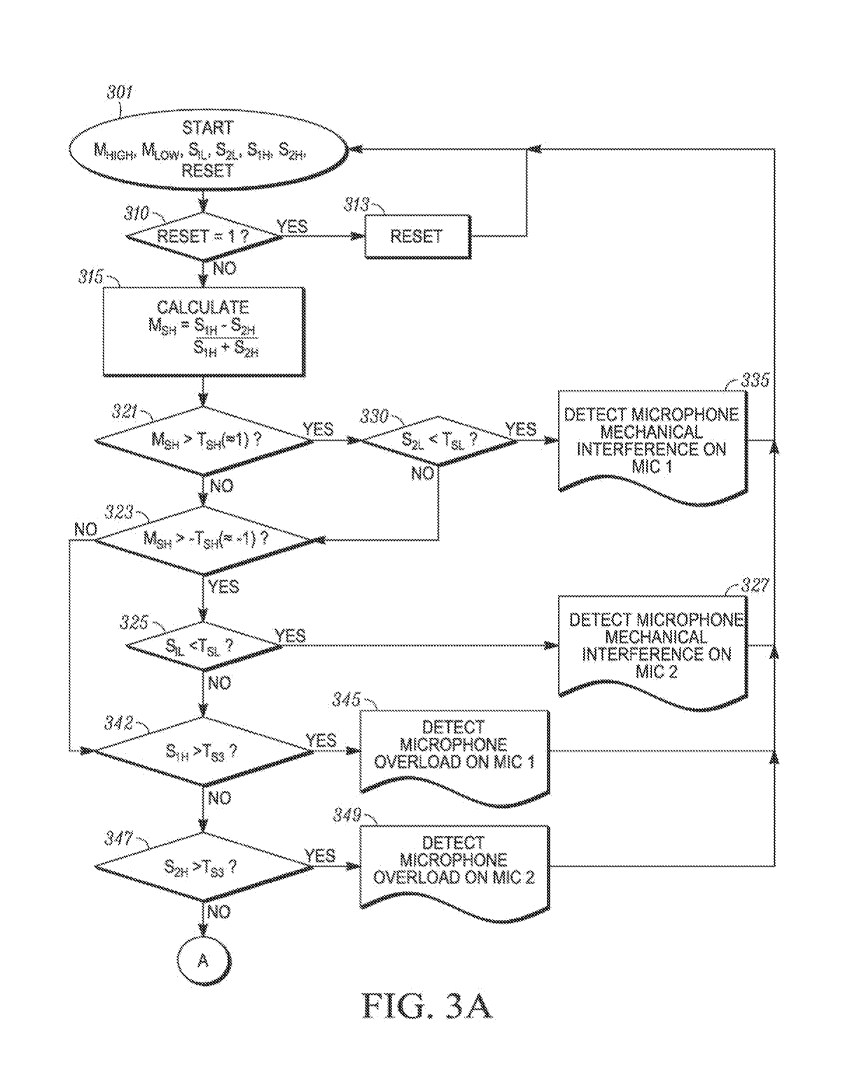

The output signal 299 of the logic control block 280 is provided to other components (not shown) of the electronic device 100 so that the electronic device can interact with the user to mitigate any detected microphone interference using, for example, the electronic display 130 or a loudspeaker (not shown). Preferably, the output signal 299 exhibits a prioritization of microphone interference causes and a hysteresis setting so that instructions can be provided to the user in an orderly fashion. For example, the types of interference that could be detected can have a priority (which will be shown with reference to FIG. 3), and the length of time for which the output signal indicates detected inference can vary. For example, if microphone interference is detected at a certain level, the output signal continues to indicate that microphone interference is detected until a predetermined lower signal level occurs. Alternately, when microphone interference is detected, a time period could elapse before the output signal again indicates microphone interference.

FIGS. 3A and 3B show an example microphone interference detection method as implemented within the logic control block 280 shown in FIG. 2. At the start 301, the seven signals M_{HIGH}, M_{LOW}, S_{1L}, S_{1H}, S_{2L}, S_{2H}, and Reset shown in FIG. 2 are received at the logic control block 280. If the Reset signal is high (e.g., Reset=1) as determined by decision block 310, then the logic control block 280 resets 313 and any historical information in the logic control block 280 is forced to zeroes. As mentioned previously, the Reset signal hay be high when the device is audibly alerting the user. This insures that noises intentionally created by the electronic device do not trigger erroneous detection of microphone interference.

If the Reset signal is not high (e.g., Reset=0), then the logic control block 280 calculates 315 a high saturation difference value M_{SH}=(S_{1H}−S_{2H})/(S_{1H}+S_{2H}) where the calculation is aborted if (S_{1H}+S_{2H})=0 to protect the calculation from “division by zero” issues. Decision block 321 determines if the magnitude of the high saturation difference value M_{SH} is greater than a predetermined high saturation count threshold T_{SH}, which can be determined experimentally. Thus, when S_{1H}>>S_{2H}, then M_{SH} tends to be near 1, and when S_{1H} is close in value to S_{2H}, then |M_{SH}| ends to be near 0.

If the high saturation difference value M_{S} has a magnitude that is greater than the high saturation count threshold T_{SH}, then decision block 330 determines if S_{2L} is less than a low saturation count threshold T_{SL}. If S_{2L}<T_{SL}, then the logic control block 280 provides an output signal 299 indicating that mechanical microphone interference has been detected 335 at the front microphone 111. In other words, there is a high saturation count (above a high saturation count threshold) at the front microphone and a low saturation count (below a low saturation count threshold) at the rear microphone. Then the flow returns to the start 301 to obtain the next set of values for M_{HIGH}, M_{LOW}, S_{1L}, S_{1H}, S_{2L}, S_{2H}, and Reset.

If either of decision blocks 321, 330 are “NO”, decision block 323 determines if the magnitude of the high saturation difference value M_{SH} is less than a negative of the predetermined high saturation count threshold (i.e., −T_{SH}). Thus, when S_{1H}<<S_{2H}, then M_{SH} tends to be near −1. If the output of decision block 323 is “YES”, then decision block 325 determines if S_{1L} is less than the low saturation count threshold T_{SL}. If S_{1L}<T_{SL}, then the logic control block 280 provides an output signal 299 indicating that mechanical microphone interference has been detected 327 at the rear microphone 115. Then the flow returns to the start 301 to obtain the next set of values for M_{HIGH}, M_{LOW}, S_{1L}, S_{1H}, S_{2L}, S_{2H}, and Reset.

If the output of decision block 323 is “NO”, then decision blocks 342, 347 check whether either high saturation count signal (e.g., S_{1H} or S_{2H}) is greater than a third saturation count threshold T_{S3}.The third saturation count threshold T_{S3} can be set equal to one of the previous saturation count thresholds (e.g., T_{SH} or T_{SL}) or may be determined independently though experimentation. If S_{1H}>T_{S3}, as determined by block 342, then the logic control block 280 provides an output signal 299 indicating that microphone overload has been detected 345 at the front microphone. If S_{2H}>T_{S3} as determined by block 347, then the logic control block 280 provides an output signal 299 indicating that microphone overload has been detected 349 at the rear microphone. If microphone overload interference has been detected at either microphone the flow returns to the start 301 to obtain the next set of values for M_{HIGH}, M_{LOW}, S_{1L}, S_{1H}, S_{2L}, S_{2H}, and Reset

If decision blocks 342, 347 do not determine S_{1H}>T_{S3} or S_{2H}>T_{S3}, then decision block 352 checks whether |M_{HIGH}|>|M_{LOW}| or M_{HIGH}>T_{HIGH}, where T_{HIGH} is a high-frequency-band energy threshold that can be determined experimentally. In other words, if the magnitude of the normalized difference between the high-band energy of the front microphone and the high-band energy of the rear microphone is greater than the magnitude of the normalized difference between the low-band energy of the front microphone and the low-band energy of the rear microphone, and the magnitude of the normalized difference between the high-band energy of the front microphone and the high-band energy of the rear microphone is greater than a high- band energy difference threshold, then the output signal 299 indicates that the logic control block 280 has detected 354 that the front microphone is experiencing occlusion. As mentioned previously, different high-frequency-band energy values can be calculated instead of the “normalized difference-of-the-energies” high-frequency-band energy values described in detail in this paragraph. Of course, the value of the corresponding threshold Thigh would change if the high-frequency-band energy values were calculated differently.

If the output of decision block 352 is “NO”, then decision block 356 checks whether |M_{HIGH}>|M_{LOW}| and M_{HIGH}>−T_{HIGH}. If the output of decision block 356 is “YES”, then the output signal 299 indicates that the logic control block 280 has detected 358 that the rear microphone is experiencing occlusion. After detection 354,358 of occlusion at either microphone, the flow then returns to the start 301 to obtain the next set of values for M_{HIGH}, M_{LOW}, S_{1H}, S_{1L}, S_{2H}, S_{2L}, and Reset.

If decision block 356 does not result in a detection of microphone occlusion, decision block 360 checks if the |M_{LOW}|>T_{LOW}, where T_{LOW} is a low-frequency-band energy threshold that may be determined experimentally. If |M₂|>T₂ then the output signal 299 indicates that the logic control block 280 has detected 365 wind noise at the microphones 111, 115. In other words, if the magnitude of the normalized difference between the low-band energy of the front microphone and the low-band energy of the rear microphone is greater than the low-band energy threshold, then the output signal 299 indicates that the logic control block 280 has detected 365 that a microphone is experiencing wind noise. As mentioned previously, different low-frequency-band energy values can be calculated instead of the “normalized difference-of-the-energies” low-frequency-band energy values described in detail in this paragraph. Of course, the value of the corresponding threshold T_{LOW} would change if the high-frequency-band energy values were calculated differently. Although, in this implementation, the wind noise detection has not been separated into wind noise detection on specific microphones, it can easily be done by checking the value M_{LOW} against positive or negative version of the threshold T_{LOW} (as explained with respect to threshold T_{HIGH}).The flow then returns to the start 301 to obtain the next set of values for M_{HIGH}, M_{LOW}, S_{1L}, S_{1H}, S_{2L}, S_{2H}, and Reset.

Thus, the input signals M_{HIGH}, M_{LOW}, S_{1L}, S_{1H}, S_{2L}, S_{2H}, and Reset are evaluated on a priority basis to detect different types of possible microphone interference. A Reset signal has the highest priority, mechanical microphone interference has a next priority, microphone overload has a third priority, microphone occlusion has a fourth priority, and wind noise has a fifth priority. These detection decisions are not used directly to compensate for the detected microphone interference, but instead are used to provide a signal to the user interface of the electronic device so that the user can be aware that microphone interference may be occurring (at the time it is occurring). Also, the output signal 299 may exhibit hysteresis so that the types of detected microphone interference can be presented to the user in an orderly fashion (and not confuse or overwhelm the user).

As mentioned previously, FIG. 1A shows an example notice 191 that could be provided to the display BO if the output signal 299 (FIG. 2) indicated that mechanical microphone interference had been detected at the front microphone. If the user checks the front microphone 111, presumably the user will inherently stop rubbing or tapping that microphone. In this example, the display 130 is a touch screen and a virtual button “DONE” has been provided so that the user can indicate that the front microphone has been checked. When the “DONE” button is pressed, the notice 191 maybe removed from the screen. In order to reduce the amount of interference with the video image being captured, the notice 191 may be presented with 50% opacity (or another effect so that the video image underlying the notice 191 is not fully obstructed).

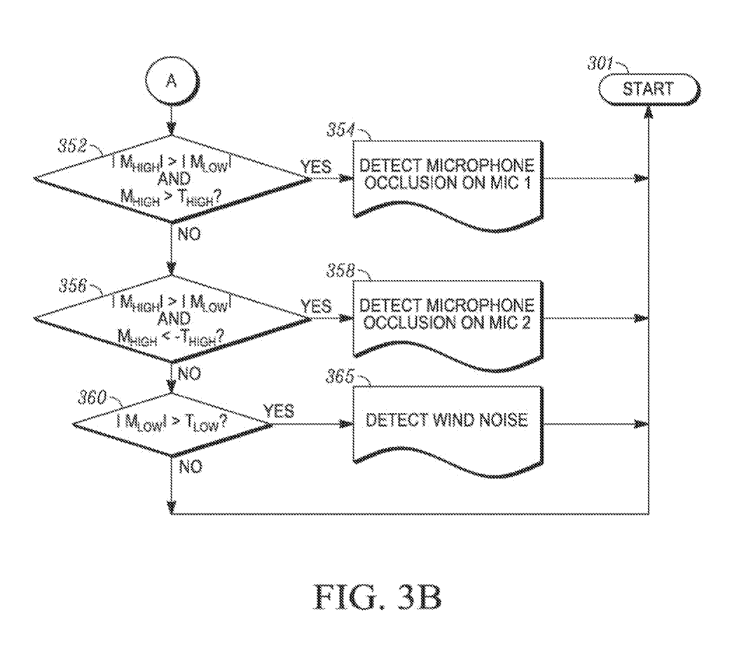

FIG. 4 shows the example electronic device of FIGS. 1A and 1B displaying a second notice 193 regarding possible microphone interference in the form of microphone overload. This notice 193 on the touch screen display 130 provides several microphone gain reduction options (“QUIET” and “QUIETER”) in addition to “NO CHANGE”. If the user selects the “QUIET” option, the microphone gain (see amplifiers 211, 215 from FIG. 2) will be reduced by a first preset amount. If the user selects the “QUIETER” option, the microphone will be reduced by a second preset amount that is greater than the first preset amount. Of course, different preset amounts can be provided and different notices can be implemented depending on the anticipated sophistication of the user. The third option, “NO CHANGE”,removes the notice 193 from the display 130 without reducing the gain of the microphone amplifiers 211, 215. A risk of not reducing the gain is that the recorded audio signal will exhibit microphone clipping.

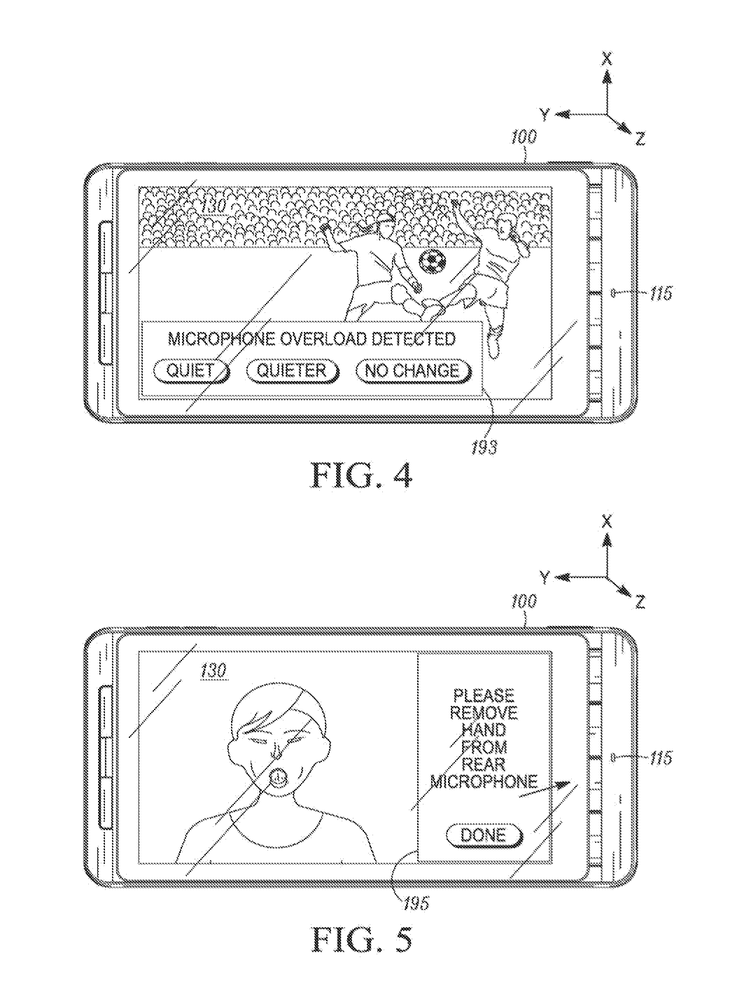

FIG. 5 shows the example electronic device of FIGS. 1A and 1B displaying a third notice 195 regarding possible microphone interference in the form of microphone occlusion. Like mechanical interference, microphone occlusion is most likely caused by the user of the electronic device 100. The simple process of checking the microphone indicated 115 and pressing the “DONE” virtual button will probably result in removal of the obstruction from the rear microphone 115 port.

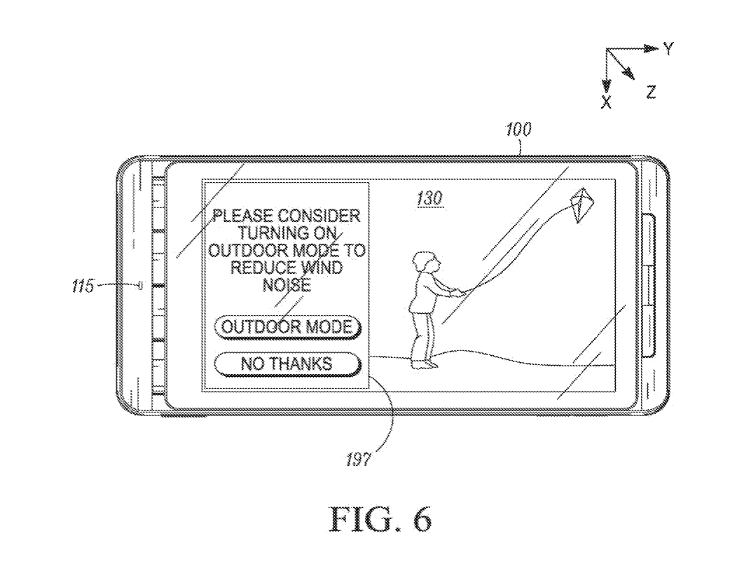

FIG. 6 shows the example electronic device of FIGS. 1A and 1B displaying a fourth notice 197 regarding possible microphone interference in the form of wind noise. This notice 197 provides an option “OUTDOOR MODE” to change the electronic device to an outdoor mode. As an example, outdoor mode can implement a wind cut filter. Alternately, the user may decide to decline switching to outdoor mode and select “NO THANKS” and either accept audio recording of wind noise or move to try to block the wind from hitting the microphones.

Thus, the microphone interference detection apparatus and method provides a mechanism to alert a user of an electronic device regarding possible audio recording interference. Because, sometimes the user is not aware of the audio interference until later playback of the recorded audio, this microphone interference detection apparatus and method gives amateur audio (and audiovisual) recorders an opportunity to mitigate potential audio interference. In other embodiments, the output of the microphone interference detection apparatus and method could be sent to one or more signal processors to try to mitigate the interference without the user being aware of the interference. The microphone interference detection apparatus and method can be integrated into a recording device and is designed to provide a methodical presentation of detected microphone interference.

While this disclosure includes what are considered presently to be the embodiments and best modes of the invention described in a manner that establishes possession thereof by the inventors and that enables those of ordinary skill in the art to make and use the invention, it will be understood and appreciated that there are many equivalents to the embodiments disclosed herein and that modifications and variations may be made without departing from the scope and spirit of the invention, which are to be limited not by the embodiments but by the appended claims, including any amendments made during the pendency of this application and all equivalents of those claims as issued.

It is further understood that the use of relational terms such as first and second, top and bottom, and the like, if any, are used solely to distinguish one from another entity, item, or action without necessarily requiring or implying any actual such relationship or order between such entities, items or actions. Much of the inventive functionality and many of the inventive principles are best implemented with or in software programs or instructions. It is expected that one of ordinary skill, not withstanding possibly significant effort and many design choices motivated by, for example, available time, current technology, and economic considerations, when guided by the concepts and principles disclosed herein will be readily capable of generating such software instructions and programs with minimal experimentation. Therefore, further discussion of such software, if any, will be limited in the interest of brevity and minimization of any risk of obscuring the principles and concepts according to the present invention.

As understood by those in the art, logic control block 280 includes a processor that executes computer program code to implement the methods described herein. Embodiments include computer program code containing instructions embodied in tangible media, such as floppy diskettes, CD-ROMs, hard drives, or any other computer-readable storage medium, wherein, when the computer program code is loaded into and executed by a processor, the processor becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

1-20. (canceled)

21. An apparatus comprising:
a first built-in microphone;
a second built-in microphone;
a first filter bank, coupled to the first built-in microphone, for creating a first high-frequency-band signal and a first low-frequency-band signal;
a second filter bank, coupled to the second built-in microphone, for creating a second high-frequency-band signal and a second low-frequency-band signal;
a first threshold block, coupled to the first filter bank, for determining when a magnitude of the first low-frequency-band signal exceeds a first threshold;
a second threshold block, coupled to the second filter bank, for determining when a magnitude of the second low-frequency-band signal exceeds a second threshold;
a third threshold block, coupled to the first filter bank, for determining when a magnitude of the first high-frequency-band signal exceeds a third threshold;
a fourth threshold block, coupled to the second filter bank, for determining when a magnitude of the second high-frequency-band signal exceeds a fourth threshold;
a first energy calculator, coupled to the first threshold block, for calculating an energy of the first low-frequency-band signal;
a second energy calculator, coupled to the second threshold block, for calculating an energy of the second low-frequency-band signal;
a third energy calculator, coupled to the third threshold block, for calculating an energy of the first high-frequency-band signal;
a fourth energy calculator, coupled to the fourth threshold block, for calculating an energy of the second high-frequency-band signal;
a first measurement calculator, coupled to the first threshold block and the second threshold block, for calculating a low-frequency-band energy value from the first low-frequency-band signal and the second low-frequency-band signal when the magnitude of the first low-frequency-band signal exceeds the first threshold and the magnitude of the second low-frequency-band signal exceeds the second threshold;
a second measurement calculator, coupled to the third threshold block and the fourth threshold block, for calculating a high-frequency-band energy value from the first high-frequency-band signal and the second high-frequency-band signal when the magnitude of the first high-frequency-band signal exceeds the third threshold and the magnitude of the second high-frequency-band signal exceeds the fourth threshold; and
a logic control block, coupled to the first measurement calculator and the second measurement calculator, for producing a first output signal indicating whether wind noise has been detected based on the low-frequency-band energy value and for producing a second output signal indicating whether microphone occlusion has been detected based on the high-frequency-band energy value.

22. The apparatus of claim 21, comprising:
a display, coupled to the logic control block, for annunciating microphone interference based on an output signal.

23. The apparatus of claim 21, comprising:
a first saturation counter, coupled to the first built-in microphone and the logic control block, for determining a first saturation count signal; and
a second saturation counter, coupled to the second built-in microphone and the logic control block, for determining a second saturation count signal;
wherein the logic control block is coupled to the first saturation counter and the second saturation counter, and the logic control block is for producing an output signal indicating microphone mechanical interference or microphone overload.

24. The apparatus of claim 23, wherein the logic control block calculates a saturation difference value by subtracting the second saturation count signal from the first saturation count signal and then dividing by a summation of the first saturation count signal and the second saturation count signal.

25. The apparatus of claim 21, wherein the first measurement calculator subtracts the energy of the second low-frequency-band signal from the energy of the first low-frequency-band signal and then divides by a summation of the energy of the first low-frequency-band signal and the energy of the second low-frequency-band signal.

26. The apparatus of claim 21, wherein the first measurement calculator calculates the low-frequency-band energy value by:
determining a first low-frequency-band energy signal from the first low-frequency-band signal;
determining a second low-frequency-band energy signal from the second low-frequency-band signal; and
subtracting the second low-frequency-band energy signal from the first low-frequency-band energy signal to produce a low-frequency-band energy difference signal.

27. The apparatus of claim 26, wherein the first measurement calculator calculates the low-frequency-band energy value by dividing the low-frequency-band energy difference signal by a summation of the first low-frequency-band energy signal and the second low-frequency-band energy signal to produce a normalized low-frequency-band energy difference signal.

28. The apparatus of claim 27, wherein the second measurement calculator calculates the high-frequency-band energy value by:
determining a first high-frequency-band energy signal from the first high-frequency-band signal;
determining a second high-frequency-band energy signal from the second high-frequency-band signal; and
subtracting the second high-frequency-band energy signal from the first high-frequency-band energy signal to produce a high-frequency-band energy difference signal.

29. A method, comprising:
receiving a first microphone signal from a first microphone;
receiving a second microphone signal from a second microphone;
filtering the first microphone signal to produce a first high-frequency-band signal and a first low-frequency-band signal;
filtering the second microphone signal to produce a second high-frequency-band signal and a second low-frequency-band signal;
calculating an energy of the first low-frequency-band signal;
calculating an energy of the second low-frequency-band signal;
calculating an energy of the first high-frequency-band signal;
calculating an energy of the second high-frequency-band signal;
calculating a low-frequency-band energy value from the first low-frequency-band signal and the second low-frequency-band signal when a magnitude of the first low-frequency-band is above a first threshold and a magnitude of the second low-frequency band signal is above a second threshold;
calculating a high-frequency-band energy value from the first high-frequency band signal and the second high-frequency band signal when a magnitude of the first high-frequency-band signal is above a third threshold and a magnitude of the second high-frequency band signals is above a fourth threshold;
producing a first output signal indicating microphone wind noise based on the low-frequency-band energy value; and
producing a second output signal indicating microphone occlusion based on the high-frequency-band energy value.

30. The method of claim 29, wherein the calculating a low-frequency-band energy value comprises:
determining a first low-frequency-band energy signal from the first low-frequency-band signal;
determining a second low-frequency-band energy signal from the second low-frequency-band signal; and
subtracting the second low-frequency-band energy signal from the first low-frequency-band energy signal to produce a low-frequency-band energy difference signal.

31. The method of claim 30, wherein the calculating a low-frequency-band energy value comprises:
dividing the low-frequency-band energy difference signal by a summation of the first low-frequency-band energy signal and the second low-frequency-band energy signal to produce a normalized low-frequency-band energy difference signal.

32. The method of claim 29, wherein the calculating a high-frequency-band energy value comprises:
determining a first high-frequency-band energy signal from the first high-frequency-band signal;
determining a second high-frequency-band energy signal from the second high-frequency-band signal; and
subtracting the second high-frequency-band energy signal from the first high-frequency-band energy signal to produce a high-frequency-band energy difference signal.

33. The method of claim 32, wherein the calculating a high-frequency-band energy value comprises:
dividing the high-frequency-band energy difference signal by a summation of the first high-frequency-band energy signal and the second high-frequency-band energy signal to produce a normalized high-frequency-band energy difference signal.

34. The method of claim 32, wherein:
the second output signal indicates occlusion of the first microphone when the first high-frequency-band energy signal is less than the second high-frequency-band energy signal; and
the second output signal indicates occlusion of the second microphone when the first high-frequency-band energy signal is greater than the second high-frequency-band energy signal.

35. The method of claim 32, comprising:
determining a first low-frequency-band energy signal from the first microphone signal;
determining a second low-frequency-band energy signal from the second microphone signal; and
calculating a low-frequency-band energy difference value from the first low-frequency-band energy signal and the second low-frequency-band energy signal;
wherein the second output signal does not indicate microphone occlusion if a magnitude of the high-frequency-band energy value is less than a magnitude of the low-frequency-band energy value.

36. The method of claim 29, comprising:
determining a first saturation count signal from the first microphone signal;
determining a second saturation count signal form the second microphone signal;
calculating a saturation difference value based on the first saturation count signal and the second saturation count signal;
producing a third output signal indicating whether mechanical microphone interference has been detected, wherein the third output signal indicates that mechanical microphone interference has been detected when the saturation difference value exceeds a first saturation count threshold.

37. The method of claim 36, wherein the calculating a saturation difference value comprises:
subtracting the second saturation count signal from the first saturation count signal to produce a saturation difference signal.

38. The method of claim 37, wherein the calculating a saturation difference value comprises:
dividing the saturation difference signal by a summation of the first saturation count signal and the second saturation count signal to produce a normalized saturation difference signal.

39. The method of claim 36, wherein the third output signal indicates mechanical interference of the first microphone has been detected when a low saturation count signal from the second microphone is less than a second saturation count threshold; and
the third output signal indicates mechanical interference of the second microphone has been detected when a low saturation count signal from the first microphone is less than the second saturation count threshold.

40. The method of claim 36, comprising:
producing a fourth output signal indicating microphone overload when the first saturation count signal exceeds a third saturation count threshold or the second saturation count signal exceeds the third saturation count threshold.
